(19) United States
(12) Patent Application Publication
(10) Pub. No.: US 2025/0390852 A1
(43) Pub. Date: Dec. 25, 2025

(54) SMART ROUTING-BASED REMOTE PAYMENT METHOD AND APPARATUS, TERMINAL, SYSTEM, AND MEDIUM

(71) Applicant: CHINA UNIONPAY CO., LTD., Shanghai (CN)

(72) Inventors: Yu WANG, Shanghai (CN); Jien ZHOU, Shanghai (CN); Zhuo CHEN, Shanghai (CN); He HUANG, Shanghai (CN); Xi SHEN, Shanghai (CN); Xinyuan XU, Shanghai (CN); Zhimin XIE, Shanghai (CN); Xiaolong WU, Shanghai (CN); Yezhou HU, Shanghai (CN); Chen CHENG, Shanghai (CN); Yongsheng HUANG, Shanghai (CN)

(21) Appl. No.: 18/878,860

(22) PCT Filed: Feb. 7, 2023
(86) PCT No.: PCT/CN2023/074832

§ 371 Date: Dec. 24, 2024

(30) Foreign Application Priority Data
Jul. 19, 2022 (CN) 202210846578.3

(51) Int. Cl. G06Q 20/08; G06F 9/54; G06Q 20/40

(52) U.S. Cl. CPC G06Q 20/085; G06F 9/547; G06Q 20/405; G06Q 20/407

(57) ABSTRACT

A smart routing-based remote payment method include: when an e-commerce application program triggers a multi-party payment entrance, calling a first SDK to send a list request message to a remote payment platform; calling the first SDK to obtain a first payment application list from the remote payment platform, the first payment application list representing a plurality of payment application programs supported by the remote payment platform and having priorities arranged from high to low; calling the first SDK to obtain a second payment application list, the second payment application list representing payment application programs owned by a user terminal; calling up, by the first SDK, a payment application program having the highest priority in an intersection of the first payment application list and the second payment application list; and calling, by the payment application program, a second SDK to interact with the remote payment platform to complete payment.

### CROSS-REFERENCE TO RELATED APPLICATION

This application claims the priority of Chinese patent application 202210846578.3, titled “SMART ROUTING-BASED REMOTE PAYMENT METHOD, TERMINAL, APPARATUS, SYSTEM, AND MEDIUM” filed on Jul. 19, 2022, the entire content of which is incorporated herein by reference.

### FIELD OF THE DISCLOSURE

The present disclosure generally relates to the field of data processing and, more particularly, relates to a smart routing-based remote payment method, terminal, apparatus, system and medium.

### BACKGROUND

With the development of payment technology, users have more and more demands for payment. In order to meet users' needs for shopping or other matters, more and more merchants have developed e-commerce application programs and provided e-commerce application programs to users. Merchants may interact with users through e-commerce application program, and users may operate e-commerce application program installed on the user terminal to carry out shopping and other matters, and pay through remote payment technology.

During the payment process, users need to manually select a payment application program on the payment interface of the e-commerce application program and jump to the payment application program to perform the payment operation, which results in low payment efficiency.

### SUMMARY

The embodiments of the present disclosure provide a smart routing-based remote payment method, terminal, apparatus, system and medium, which may improve payment efficiency.

In a first aspect, the embodiments of the present disclosure provide a smart routing-based remote payment method, which is applied to a user terminal. The user terminal user terminal includes an e-commerce application program, a first software development kit (SDK) integrated in the e-commerce application program, a payment application program, and a second SDK integrated in the payment application program, where the e-commerce application program belongs to a first entity, the payment application program belongs to a second entity, the first SDK and the second SDK belong to a third entity, and the method including: when the e-commerce application program triggers a multi-party payment entrance, calling the first SDK to send a list request message to a remote payment platform, where the list request message includes list requirement information, where the list requirement information includes an e-commerce application identifier and a user identifier; calling the first SDK to obtain a first payment application list from the remote payment platform, where the first payment application list represents a plurality of payment application programs supported by the remote payment platform and ranked in a descending order of priority, where the priority is obtained by the remote payment platform based on associated data corresponding to the list requirement information; calling the first SDK to obtain a second payment application list, where the second payment application list represents payment application programs owned by the user terminal; calling up, by the first SDK, a first target payment application program, where the first target payment application program is a payment application program with a highest priority in an intersection of the first payment application list and the second payment application list; and interacting, through a second SDK called by the first target payment application program, with the remote payment platform to complete a payment.

In a second aspect, the embodiments of the present disclosure provide a smart routing-based remote payment method, which is applied to a remote payment platform. The payment method includes: when an e-commerce application program of a user terminal triggers a multi-party payment entrance, receiving a list request message sent by a SDK called by the user terminal, where the list request message includes list requirement information, where the list requirement information includes an e-commerce application identifier and a user identifier, the user terminal has the e-commerce application program, the first SDK integrated in the e-commerce application program, a payment application program, and a second SDK integrated in the payment application program, the e-commerce application program belongs to a first entity, the payment application program belongs to a second entity, and the first SDK and the second SDK belong to a third entity; according to the list request message, obtaining associated data corresponding to the list requirement information, and based on the associated data, obtaining priorities of payment application programs supported by the remote payment platform; according to the priorities of the payment application programs supported by the remote payment platform, generating and sending a first payment application list to the user terminal, where the first payment application list represents a plurality of payment application programs supported by the remote payment platform and ranked in a descending order of priority; and interacting with a second SDK of a first target payment application program of the user terminal to complete a payment, where the first target payment application program is a payment application program with a highest priority in an intersection of the first payment application list and a second payment application list, and the second payment application list represents payment application programs owned by the user terminal.

In a third aspect, the embodiments of the present disclosure provide a user terminal. The user terminal includes: an e-commerce application program, a first SDK integrated in the e-commerce application program, a payment application program, and a second SDK integrated in the payment application program, the e-commerce application program belonging to a first entity, the payment application program belonging to a second entity, the first SDK and the second SDK belonging to a third entity, and the user terminal includes: a communication module, configured to be called by the first SDK to send a list request message to a remote payment platform when the e-commerce application program triggers a multi-party payment entrance, where the list request message includes list requirement information, where the list requirement information includes an e-commerce application identifier and a user identifier; and configured to be called by the first SDK to obtain a first payment application list from a remote payment platform, where the first payment application list represents a plurality of payment application programs supported by the remote payment platform and ranked in a descending order of priority, and the priority is obtained by the remote payment platform based on associated data corresponding to the list requirement information; and a processing module, configured to be called by the first SDK to obtain a second payment application list, where the second payment application list represents payment application programs possessed by the user terminal; and configured to be called by the first SDK to call up a first target payment application program, where the first target payment application program is a payment application program with a highest priority in an intersection of the first payment application list and the second payment application list, where the communication module is further configured to be called by a second SDK of the first target payment application program to interact with the remote payment platform to complete a payment.

In a fourth aspect, the embodiments of the present disclosure provide a smart routing-based remote payment apparatus, which is applied to a remote payment platform. The smart routing-based remote payment apparatus includes: a communication module, configured to receive, when an e-commerce application program of a user terminal triggers a multi-party payment entrance, a list request message sent by a first SDK called by the user terminal, where the list request message includes list requirement information, where the list requirement information includes an e-commerce application identifier and a user identifier, the user terminal has the e-commerce application program, the first SDK integrated in the e-commerce application program, a payment application program, and a second SDK integrated in the payment application program, the e-commerce application program belongs to a first entity, the payment application program belongs to a second entity, and the first SDK and the second SDK belong to a third entity; and a processing module, configured to obtain, according to the list request message, associated data corresponding to the list requirement information, and obtain, based on the associated data, priorities of payment application programs supported by the remote payment platform; and, configured to generate, according to the priorities of the payment application programs supported by the remote payment platform, a first payment application list, where the first payment application list represents a plurality of payment application programs supported by the remote payment platform, ranked in a descending order of priority, where the communication module is further configured to send the first payment application list to the user terminal, and interact with a second SDK of a first target payment application program of the user terminal to complete a payment, the first target payment application program is a payment application program with a highest priority in an intersection of the first payment application list and a second payment application list, and the second payment application list represents payment application programs possessed by the user terminal.

In a fifth aspect, the embodiments of the present disclosure provide a user terminal, where the user terminal includes: a processor and a memory storing computer program instructions; when the processor executes the computer program instructions, the smart routing-based remote payment method of the first aspect is implemented.

In a sixth aspect, the embodiments of the present disclosure provide an electronic device, which is applied to a remote payment platform. The electronic device includes: a processor and a memory storing computer program instructions; when the processor executes the computer program instructions, the smart routing-based remote payment method of the second aspect is implemented.

In the seventh aspect, the embodiments of the present disclosure provide a remote payment system, where the payment system includes: a user terminal, where the user terminal includes an e-commerce application program, a first SDK integrated in the e-commerce application program, a payment application program, and a second SDK integrated in the payment application program. The e-commerce application program belongs to a first entity, the payment application program belongs to a second entity, the first SDK and the second SDK belong to a third entity; the user terminal is configured to execute the smart routing-based remote payment method of the first aspect; and a remote payment platform is configured to execute the smart routing-based remote payment method of the second aspect.

In an eighth aspect, the embodiments of the present disclosure provide a computer-readable storage medium with computer program instructions stored. When the computer program instructions are executed by a processor, the smart routing-based remote payment method of the first aspect or the smart routing-based remote payment method of the second aspect is implemented.

The embodiments of the present disclosure provide a smart routing-based remote payment method, terminal, apparatus, system and medium. When the e-commerce application program triggers the multi-party payment entrance, the user terminal uses the first SDK integrated in the e-commerce application program to interact with the remote payment platform and provide the remote payment platform with list requirement information, so that the remote payment platform provides a list of multiple payment application programs supported by the remote payment platform, with the priority ranked from high to low, corresponding to the list requirement information. Through the payment application programs locally presented in the user terminal and the multiple payment application programs, supported by the remote payment platform in a descending order of priority, provided by the remote payment platform, the first SDK determines a local payment application program with the highest priority and automatically calls it up without the need for the user to manually select the payment application program. The automatically called local payment application program with the highest priority, i.e., the first target payment application program, may call the second SDK to interact with the remote payment platform to complete the payment. In the remote payment process, the user does not need to manually select a payment application program, and the payment application program adapted to the e-commerce application program and the user may be automatically called up for payment, thereby improving the payment efficiency.

### BRIEF DESCRIPTION OF THE DRAWINGS

In order to explain the technical solutions of the embodiments of the present disclosure more clearly, the following drawings essential for the embodiments of the present disclosure will be briefly described below. For a person skilled in the art, other drawings may be obtained without any creative work.

FIG. 1 is an architecture diagram of an application scenario of an example of a smart routing-based remote payment method in accordance with an embodiment of the present disclosure;

FIG. 2 is a flowchart of a smart routing-based remote payment method in accordance with an embodiment of the first aspect of the present disclosure;

FIG. 3 is a flowchart of a smart routing-based remote payment method in accordance with another embodiment of the first aspect of the present disclosure;

FIG. 4 is a flowchart of a smart routing-based remote payment method in accordance with another embodiment of the first aspect of the present disclosure;

FIG. 5 is a flowchart of a smart routing-based remote payment method in accordance with another embodiment of the first aspect of the present disclosure;

FIG. 6 is a flowchart of a smart routing-based remote payment method in accordance with an embodiment of the second aspect of the present disclosure;

FIG. 7 is a flowchart of a smart routing-based remote payment method in accordance with another embodiment of the second aspect of the present disclosure;

FIG. 8 is a flowchart of a smart routing-based remote payment method in accordance with another embodiment of the second aspect of the present disclosure;

FIG. 9 is a flowchart of a smart routing-based remote payment method in accordance with another embodiment of the second aspect of the present disclosure;

FIG. 10 is a flowchart of an example of a smart routing-based remote payment process in accordance with an embodiment of the present disclosure;

FIG. 11 is a flowchart of another example of a smart routing-based remote payment process in accordance with an embodiment of the present disclosure;

FIG. 12 is a schematic structure diagram of a user terminal in accordance with an embodiment of the third aspect of the present disclosure;

FIG. 13 is a schematic structure diagram of a smart routing-based remote payment apparatus in accordance with an embodiment of the fourth aspect of the present disclosure; and

FIG. 14 is a schematic structure diagram of a user terminal in accordance with an embodiment of the fifth aspect of the present disclosure.

### DETAILED DESCRIPTION

The features and exemplary embodiments of various aspects of the present disclosure will be described in details below. In order to make the purpose, technical solutions and advantages of the present disclosure clearer, the present disclosure will be further described in details below with the accompanying drawings and specific embodiments. It should be noted that the specific embodiments described here are only intended to explain the present disclosure, but not to limit the present disclosure. For those skilled in the art, the present disclosure may be implemented without some of these specific details. The following description of the embodiments is merely intended to provide a better understanding of the present disclosure by illustrating the examples of the embodiments.

With the development of payment technology, users have more and more demands for payment. In order to meet users' needs for shopping or other matters, more and more merchants have developed e-commerce application programs and provided e-commerce application programs to users. Merchants may interact with users through e-commerce application program, and users may operate e-commerce application program installed on a user terminal to carry out shopping and other matters and pay through remote payment technology. During the payment process, users need to manually select a payment application program on the payment interface of the e-commerce application program and jump to the payment application program to make payment operations, which has low payment efficiency.

The present disclosure provides a smart routing-based remote payment method, terminal, apparatus, system and medium, which may interact with the remote payment platform through the interaction between the user terminal and the remote payment platform. When the e-commerce application program triggers a multi-party payment entrance, the SDK integrated in the e-commerce application program interacts with the remote payment platform to automatically determine and pull up the payment application program, so that the user may make a payment without manually selecting the payment application program.

In the embodiments of the present disclosure, the smart routing-based remote payment method may involve entities such as a user, a merchant, a remote payment management entity and a card issuer. The merchant may provide an e-commerce application program for the user, and an institution such as the card issuer may provide a payment application program for the user. The remote payment management entity may provide an SDK integrated in the e-commerce application program and an SDK integrated in the payment application program. The user may use a user terminal with the e-commerce application program, the SDK integrated in the e-commerce application program, the payment application program and the SDK integrated in the payment application program to interact with the platform of the remote payment management entity, so that the platform of the remote payment management entity interacts with the resource management system, and the resource management system completes the transfer in/out of resources in the user's resource card to realize payment.

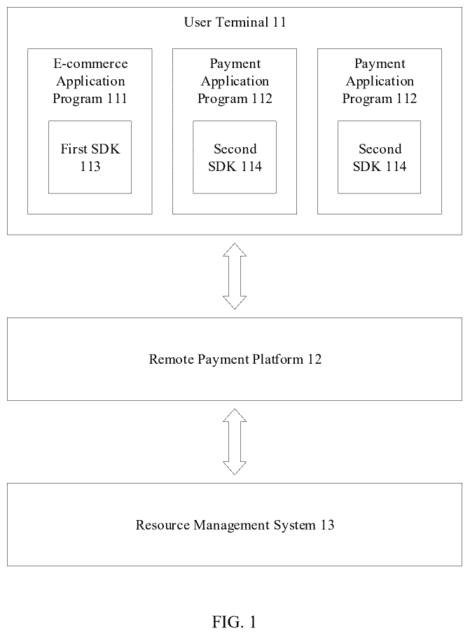

For example, FIG. 1 is an architecture diagram of an application scenario of an example of a smart routing-based remote payment method in accordance with an embodiment of the present disclosure. As shown in FIG. 1, the remote payment system may include a user terminal 11, a remote payment platform 12 and a resource management system 13.

The user terminal 11 has an e-commerce application program 111 and payment application programs 112. The e-commerce application program 111 is integrated with a first SDK 113, and a payment application program 112 is integrated with a second SDK 114. The e-commerce application program belongs to a first entity, the payment application program belongs to a second entity, and the first SDK and the second SDK belong to a third entity. The first entity may be a merchant, etc., the second entity may be a card issuing bank, a payment service provider, etc., and the third entity may be a remote payment management entity such as a card organization and an acquirer, which is not limited here. In some embodiments, the second entity and the third entity may be the same entity. For example, when the third entity may also develop and provide a payment application program to the user, the user terminal 11 may use the payment application program of the third entity to make a payment, and the second entity and the third entity may be the same entity. The first SDK may provide an order processing function and a function of calling a payment application program. The second SDK may provide payment functions such as payment controls, active code scanning, and passive code scanning. The user terminal 11 may include a terminal device that may make a payment, such as a mobile phone, a tablet computer, and a wearable device, and the type of the user terminal 11 is not limited here. The user terminal 11 may communicate and interact with the remote payment platform 12 through the first SDK 113 and the second SDK 114.

The remote payment platform 12 is a service platform of the remote payment management party, which may manage the first SDK 113 and the second SDK 114, communicate and interact with the first SDK 113 and the second SDK 114, and may also authorize and activate the multi-party payment function of the user's payment application program and process the resource card binding, and may also process and perform a statistic processing on the payment. The multi-party payment function refers to the function of the payment application program to access the remote payment platform through the integrated second SDK to make payments. The payment of the payment application program that has activated the multi-party payment function may be made through the remote payment platform 12. The user may either go to the issuing bank or through the payment application program to activate the multi-party payment function of the payment application program on the terminal device. The remote payment platform 12 may include multiple electronic devices such as servers, and the type and number of electronic devices in the remote payment platform 12 are not limited here. The remote payment platform 12 may communicate and interact with the resource management system 13, and the resource management system 13 may complete the transfer in/out of resources in the resource card configured by the user for payment.

Hereinafter described in sequence include the smart routing-base remote payment method, user terminal, apparatus, device, system and medium in accordance with the present disclosure.

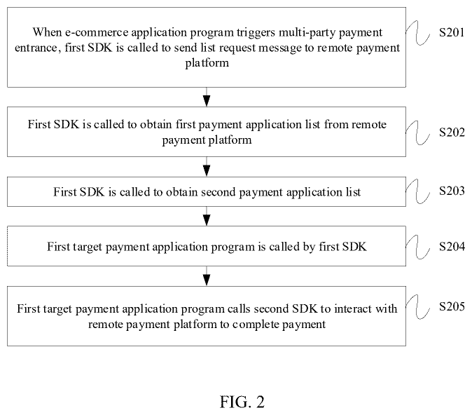

The first aspect of the present disclosure provides a smart routing-based remote payment method, which may be applied to a user terminal, that is, the smart routing-based remote payment method may be executed by a user terminal. The user terminal includes an e-commerce application program, a first SDK integrated in the e-commerce application program, a payment application program, and a second SDK integrated in the payment application program. The specific contents of the e-commerce application program, the first SDK, the payment application program, and the second SDK may be found in the relevant descriptions in the above embodiments, which will not be repeated here. FIG. 2 is a flowchart of a smart routing-based remote payment method in accordance with an embodiment of the first aspect of the present disclosure. As shown in FIG. 2, the smart routing-based remote payment method may include Steps S201 to S205.

In Step S201, when the e-commerce application program triggers a multi-party payment entrance, the first SDK is called to send a list request message to the remote payment platform.

The multi-party payment entrance is an entry for the multi-party payment function in the e-commerce merchant application program. When the multi-party payment entrance is triggered, payment is made using the multi-party payment function. For example, a user inputs in the order interface of the multi-party payment entrance to trigger the multi-party payment entrance. The multi-party payment entrance may be implemented as a trigger control for the multi-party payment function, which is not limited here. When the multi-party payment entrance is triggered, the user terminal may call the first SDK integrated in the e-commerce application program to send a list request message to the remote payment platform.

The list request message is used to request a list of payment application programs from the remote payment platform. The list request message may include list requirement information. The list requirement information represents the requirements for the payment application programs represented in the list of requested payment application programs. The information in the obtained list of requested payment application programs may be different when the list requirement information is different. The list requirement information may include an e-commerce application identifier and a user identifier. The e-commerce application identifier is configured to identify the e-commerce application program and may include a serial number and name of the e-commerce application program, and other information that may uniquely identify the e-commerce application program on the remote payment platform, which is not limited here. The user identifier is configured to identify the user and may include the user's account name, desensitized user personal information, and other information that may uniquely identify the user on the remote payment platform, which is not limited here.

In some embodiments, the list requirement information may also include one or more of the following: the version of the user terminal operating system, the version of the first SDK, and the version of the second SDK. The user terminal operating system version represents the version of the user terminal operating system. Different user terminal operating system versions, different versions of the first SDK, and different versions of the second SDK may support different payment application programs. Accordingly, the information in the requested payment application list may be different.

In some embodiments, the list request message may also include order information so that the remote payment platform may process the order according to the order information. Alternatively, before, after, or at the same time as the user terminal calls the first SDK to send the list request message to the remote payment platform, the first SDK may also be called to send the order information to the remote payment platform so that the remote payment platform may process the order according to the order information.

In Step S202, the first SDK is called to obtain a first payment application list from the remote payment platform.

The first payment application list represents multiple payment application programs supported by the remote payment platform, which are ranked from high to low priority. Specifically, the first payment application list may include the identifiers of multiple payment application programs supported by the remote payment platform, which are ranked from high to low priority, and each identifier may represent a payment application program. The referred priority is the priority at which a payment application program is called, which may be obtained by the remote payment platform based on the associated data corresponding to the list requirement information.

When the remote payment platform receives the list request message, it may obtain the associated data corresponding to the list requirement information according to the list requirement information in the list request message; obtain the priorities for the payment application programs supported by the remote payment platform according to the associated data; generate a first payment application list according to the priority, and provide the first payment application list to the first SDK of the user terminal. The payment application programs supported by the remote payment platform include payment application programs of the second entity that have activated the multi-party payment function. It should be noted that a payment application program of the second entity activates the multi-party payment function, which means that the second entity authorizes the payment application program to have the permission to activate the multi-party payment function. A payment application program in the user terminal still needs the user to activate the multi-party payment function before it has the multi-party payment function.

The associated data includes historical payment data and/or customized data associated with the list requirement information. Different list requirement information may correspond to different associated data, and different associated data may correspond to different first payment application list, that is, different list requirement information may correspond to different first payment application list.

For example, the list requirement information including the e-commerce application identifier and the user identifier. When the user identifier is the same and the e-commerce application identifier is different, the historical payment data and/or customized data associated with different e-commerce application programs configured by the same user may be different, and the obtained first payment application list may also be different. When the user identifier is different and the e-commerce application identifier is the same, the historical payment data and/or customized data associated with the same e-commerce application program configured by different users may be different, and the obtained first payment application list may also be different. When the user identifier is different and the e-commerce application identifier is different, the historical payment data and/or customized data associated with different e-commerce application programs configured by different users may be different, and the obtained first payment application list may also be different.

For another example, the list requirement information also includes the version of the user terminal operating system. The payment application programs supported by different versions of user terminal operating system may be different, and the obtained first payment application list may also be different. The list requirement information also includes the version of the first SDK. The payment application program supported by different versions of first SDK may be different, and the obtained first payment application list may also be different. The list requirement information also includes the version of the second SDK. The payment application program corresponding to different versions of second SDK may be different, and the obtained first payment application list may also be different.

The types of associated data are not limited here, and the priority determination strategy for determining the priority of a payment application program based on the associated data may be set according to the type of associated data, specific scenarios, requirements, etc., and is not limited here. When the associated data includes multiple items, a weight may be set for each associated data, and the priority of a payment application program is determined based on the weights and using a weighted algorithm. In some embodiments, the associated data includes one or more of the following: payment frequency of a payment application program, payment success rate of a payment application program, payment resources amount of a payment application program, payment time of a payment application program, payment credit limit of the user in a payment application program, the call-up sequence of payment application programs specified by the first entity, and the call-up sequence of payment application programs specified by the third entity.

The payment frequency of a payment application program is the frequency at which the payment application program is used for payment. In some embodiments, the higher the payment frequency of the payment application program, the higher the priority of the payment application program. The payment success rate of a payment application program is the success rate of the payment application program being used for payment. In some embodiments, the higher the payment success rate of the payment application program, the higher the priority of the payment application program. The payment resource amount of a payment application program is the amount of resources of the payment application program used for payment. The resource amount may include one or more of the total resource amount, the average resource amount, the resource amount of the most recent payment, etc., which are not limited here. In some embodiments, the higher the payment resource amount of the payment application program, the higher the priority of the payment application program. The payment time of a payment application program may include the timestamp of the payment application program being used for payment. The order in which each payment application program is used within a time period may be determined according to the payment time of the payment application program. In some embodiments, the closer the payment time of the payment application program is to the current time, the higher the priority of the payment application program. The payment credit limit of the user in a payment application program is the credit limit of the user using the payment application program for payment. In some embodiments, the higher the payment credit limit of the user in the payment application program, the higher the priority of the payment application program. The call-up sequence of payment application programs specified by the first entity includes the order, pre-set by the first entity, in which the payment application programs are called up by the first SDK. In some embodiments, in the call-up sequence of payment application programs specified by the first entity, the priority for a payment application program placed earlier in the sequence is higher than the priority of a payment application program placed later in the sequence. The call-up sequence of payment application programs specified by the third entity includes the sequence, pre-set by the third entity, in which the payment application programs are called up by the first SDK. In some embodiments, in the call-up sequence of payment application programs specified by the third entity, the priority for a payment application program placed earlier in the sequence is higher than the priority of a payment application program placed later in the sequence.

For example, the associated data includes the payment success rate of a payment application program, and the priority determination strategy is that the higher the payment success rate of the payment application program, the higher the priority. Assume that the payment application program payment success rate for a payment application program C1 used by user A1 in e-commerce application program B1 is 99.3%, the payment application program payment success rate for a payment application program C2 used by user A1 in e-commerce application program B1 is 99.5%, and the payment application program payment success rate for a payment application program C3 used by user A1 in e-commerce application program B1 is 99%. Then, the payment application programs in the first payment application list corresponding to the list request message including the identifier of user A1 and the identifier of e-commerce application program B1 are ranked in a descending order of priority as payment application program C2, payment application program C1, and payment application program C3. Assume that the payment application program payment success rate for a payment application program C2 used by user A1 in e-commerce application program B2 is 99.6%, the payment application program payment success rate for a payment application program C3 used by user A1 in e-commerceapplication program B2 99.1%, and the payment application program payment success rate for a payment application program C4 used by user A1 in e-commerce application program B2 is 99.3%. The priority determination strategy is that the higher the payment success rate, the higher the priority. The payment application programs in the first payment application list corresponding to the list request message including the identifier of user A1 and the identifier of e-commerce application program B2 are ranked in a descending order of priority as payment application program C2, payment application program C4, and payment application program C3. The first payment application list obtained according to different list requirement information is different.

For another example, the associated data includes the payment time of a payment application program, and the priority determination strategy is that the closer the payment time of a payment application program is to the current time, the higher the priority. Assume that the current time is 18:00 on Jun. 27, 2022, the payment application program payment time when user A1 uses a payment application program C1 in e-commerce application program B1 is 9:05 on Jan. 15, 2022, the payment application program payment time when user A1 uses a payment application program C2 in e-commerce application program B1 is 15:32 on May 26, 2022, and the payment application program payment time when user A1 uses a payment application program C3 in e-commerce application program B1 is 21:16 on Jun. 23, 2022. Then, the payment application programs in the first payment application list corresponding to the list request message including the identifier of user A1 and the identifier of e-commerce application program B1 are ranked from high to low in terms of priority as payment application program C3, payment application program C2, and payment application program C1.

In Step S203, the first SDK is called to obtain a second payment application list.

The second payment application list represents the payment application programs that the user terminal has. The payment application programs that the user terminal has is the payment application programs that the user terminal has installed. The first SDK may perform an identifier check on the scheme of the payment application programs local to the user terminal, etc., to determine the payment application programs installed by the user terminal. Specifically, the second payment application list may include the identifiers of the payment application programs that the user terminal has.

In Step S204, a first target payment application program is called by the first SDK.

The first target payment application program is a payment application program with the highest priority in the intersection of the first payment application list and the second payment application list. The first SDK may select the intersection of the payment application programs represented by the first payment application list and the payment application programs represented by the second payment application list, and determine a payment application program with the highest priority in the intersection as the first target payment application program and call it up. The first target payment application program may be automatically started after being called up, that is, the user terminal automatically jumps to the first target payment application program.

For example, the payment application programs in the first payment application list ranked in a descending order of priority are payment application program C3, payment application program C1, payment application program C4, payment application program C2 and payment application program C5, and the payment application programs in the second payment application list are payment application program C1, payment application program C2 and payment application program C4. Then, the first target payment application program is payment application program C1, and the first SDK calls up the first target payment application program to enable the first target payment application program to participate in the payment process.

Different operating systems of the user terminal may use different methods to call up the first target payment application program. For example, in some operating systems, the first target payment application program may be called up by scheme, and in other operating systems, the first target payment application program may be called up by intent.

In some embodiments, the first SDK may initiate a call-up message to the first target payment application program, and the call-up message may include first information and second information, the first information may be used to instruct the first target payment application program to automatically start, and the second information may be used to instruct to call up a page displayed by the first target payment application program. The first target payment application program automatically starts in response to the call-up message and jumps directly to the page indicated by the call-up message. The page indicated by the call-up message may be a payment page or other pages, which is not limited here. In some embodiments, a list of trusted payment application programs may be stored in the scheme, and the payment application programs recorded in the list of trusted payment application programs are payment application programs that may be called up by the first SDK, that is, payment application programs to which the first SDK has the authority to send the call-up message.

In this example, after the user triggers the multi-party payment entrance, the user does not need to perform a confirmation operation, nor does the user need to select a payment application program from a list. The payment application program with the highest priority in the user terminal may be directly called up, shortening the remote control of a payment process, reducing the user's cumbersome operation path, and improving the user experience.

In Step S205, the first target payment application program calls the second SDK to interact with the remote payment platform to complete the payment.

The first target payment application program is called up, and the first target payment application program will call the second SDK integrated in itself to interact with the remote payment platform, so that the remote payment platform interacts with the resource management system, completes the transfer in/out of the payment resources, and completes the payment.

The second SDK of the first target payment application program may send a payment request message to the remote payment platform. The payment request message may include a user identifier. In response to the payment request message, the remote payment platform feeds back a resource card list to the second SDK, and the resource card list represents the resource cards corresponding to the user identifier. In some embodiments, when the first target payment application program activates a multi-party payment function, the resource card list may represent all resource cards corresponding to the user identifier in the remote payment platform, not just the resource cards bound to the first target payment application program. That is, the resource card list may represent the resource cards bound to the user corresponding to the user identifier in each payment application program authorized to activate the multi-party payment function. In some embodiments, the resource card list may represent the resource cards bound to the first target payment application program by the user corresponding to the user identifier. The user terminal may display the resource card list to the user, and the second SDK determines a target resource card selected by the user in response to the user's input for the resource card list, and sends a payment message to the remote payment platform. The payment message may include the identifier of the target resource card and the amount of payment resources. In response to the payment message, the remote payment platform sends a payment message to the resource management system, and the resource management system transfers the resource including the payment resource amount from the target resource card to complete the payment.

The ranking order of resource cards in the resource card list may be obtained according to the card ranking factor information. The card ranking factor information may be set according to the scene, demand, etc., and is not limited here. In some embodiments, the card ranking factor information may include one or more of the resource card binding order, resource card usage time, payment application program to which a resource card belongs, resource card attributes, resource amount in the resource card, resource card status, etc. For example, the resource cards in the resource card list may be ranked from early to late according to the resource card binding order, or the resource cards in the resource card list may be ranked from near to far according to the resource card usage time from the current time, or the resource cards in the resource card list may give priority to the resource cards belongs to a payment application program being called up. In some embodiments, in addition to determining the ranking order of resource cards in the resource card list, the card ranking factor may also mark the resource cards that may be used in the resource card list or mark the resource cards that cannot be used in the resource card list. The marking method is not limited here, and may be marked in the form of font, color, bold, underline, etc. For example, when the resource card attribute is a credit card, the amount of resources in a resource card is insufficient for payment, or the resource card status is a non-payable state, the resource card logo may be set to gray and ranked at the bottom of the resource card list. The non-payable status may include card cancellation status, report loss status, stop payment status, restriction status, uncontracted status, inactivated status, etc., which are not limited here.

In some embodiments, regardless of whether the payment is successful, the remote payment platform may send payment result information to the second SDK of the first target payment application program, and the second SDK may transmit the payment result information to the first SDK in the e-commerce application program. The first SDK may transmit the payment result information to the e-commerce application program so that the e-commerce application program displays the payment result information to the user. The payment result information is used to indicate whether the payment is successful or failed. In the case of a successful payment, the second SDK may call up the e-commerce application program so that the e-commerce application program notifies the user that the payment is successful.

In the embodiments of the present disclosure, when the e-commerce application program triggers a multi-party payment entrance, the user terminal uses the first SDK integrated in the e-commerce application program to interact with the remote payment platform and provide the remote payment platform with list requirement information, so that the remote payment platform provides a list of payment application programs supported by the remote payment platform in a descending order of priority corresponding to the list requirement information. Through the payment application programs locally presented in the user terminal and the multiple payment application programs, supported by the remote payment platform in a descending order of priority, provided by the remote payment platform, the first SDK determines a local payment application program with the highest priority and automatically calls it up without the need for the user to manually select the payment application program. The automatically called locally presented payment application program with the highest priority, i.e., the first target payment application program, may call the second SDK to interact with the remote payment platform to complete the payment. In the remote payment process, the user does not need to manually select the payment application program, and the payment application program, adapted to the e-commerce application program and the user, may be automatically called up for payment, thereby improving the payment efficiency.

In addition, the remote payment platform provides a first payment application list representing payment application programs ranked in a descending order of priority, so that the first SDK in the user terminal may automatically call up the local payment application program with the highest priority for payment. Without the need for the user to perform a payment application program selection operation, the payment application program with the highest priority is actively called up for the user. The payment application program recommendation process is a smart routing process, which achieves accurate and reasonable recommendation of the payment application program, that is, achieves accurate and reasonable automatic selection of the payment method.

Moreover, the first SDK belonging to a third entity is integrated into an e-commerce application program belonging to the first entity, and the second SDK belonging to the third entity is integrated into a payment application program belonging to the second entity, so that the e-commerce application program and multiple payment application programs may access the remote payment platform belonging to the third entity, achieving the multi-party payment function. It can be seen that the multi-party payment function enables multiple payment application programs to access the same remote payment platform, achieves the online platform sharing of multiple payment application programs, optimizes the remote-control payment process, shortens the user payment operation path, and improves the user experience.

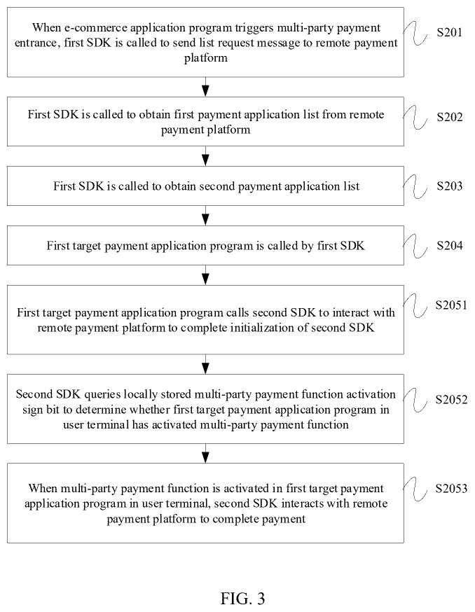

In some embodiments, the second entity to which the first target payment application program belongs authorizes the first target payment application program to have the permission to activate the multi-party payment function, but the first target payment application program in the user terminal may not have activated the multi-party payment function yet. Therefore, during the payment process, it is necessary to check whether the first target payment application program in the user terminal has activated the multi-party payment function. FIG. 3 is a flowchart of a smart routing-based remote payment method in accordance with another embodiment of the first aspect of the present disclosure. The difference between FIG. 3 and FIG. 2 is that Step S205 in FIG. 2 may be specifically refined into Steps S2051 to S2053 in FIG. 3.

In Step S2051, the first target payment application program calls the second SDK to interact with the remote payment platform to complete the initialization of the second SDK.

The second SDK is integrated in the payment application program. When the payment application program is called up and the second SDK of the payment application program is needed, the second SDK needs to be initialized. The second SDK may call the “init” interface (i.e., the initialization interface) for initialization. Initialization may include initialization of the environment. The second SDK may send the acquired environmental parameters and other parameters required for initialization to the remote payment platform. The remote payment platform determines whether the second SDK may be initialized and provides feedback to the second SDK. The second SDK may determine whether to continue initialization based on the determination result of the remote payment platform.

In some embodiments, if the first target payment application program is used for the first time on the user terminal, the first target payment application program may also display a privacy information authorization page to prompt the user to authorize the first target payment application program to use the user information. The privacy information authorization page may include a privacy information authorization description, an authorization consent option, and an authorization rejection option. If the user agrees to authorize the first target payment application program to use the user information, the second SDK of the first target payment application program may be proceeded for initialization. If the first target payment application program has previously been authorized by the user to use the user information, there is no need to display the privacy information authorization page again, and the second SDK of the first target payment application program may be initialized directly.

In Step S2052, the second SDK queries a locally stored multi-party payment function activation sign bit to determine whether the first target payment application program in the user terminal has activated the multi-party payment function.

After the second SDK is successfully initialized, the second SDK also needs to determine whether the first target payment application program in the user terminal has activated the multi-party payment function. If the first target payment application program in the user terminal has not activated the multi-party payment function, the second SDK cannot interact with the remote payment platform to complete the subsequent payment process.

The multi-party payment function activation sign bit may indicate whether the first target payment application program in the user terminal has activated the multi-party payment function. The multi-party payment function activation sign bit may be represented by numbers, letters or other characters, which are not limited here. For example, if the multi-party payment function activation sign bit is 1, it means that the first target payment application program in the user terminal has activated the multi-party payment function; if the multi-party payment function activation sign bit is 0, it means that the first target payment application program in the user terminal has not activated the multi-party payment function.

In Step S2053, when the multi-party payment function is activated in the first target payment application program in the user terminal, the second SDK interacts with the remote payment platform to complete the payment.

The first target payment application program in the user terminal activates the multi-party payment function, which means that the first target payment application program in the user terminal has the authority to interact with the remote payment platform to complete the payment, and the second SDK may interact with the remote payment platform.

In some embodiments, Step S2053 may be further refined as follows: when the first target payment application program in the user terminal activates the multi-party payment function, the second SDK determines whether the user has logged into the first target payment application program. When the user has logged into the first target payment application program, the second SDK interacts with the remote payment platform to complete the payment. If the user is not logged into the first target payment application program, it means that the first target payment application program has not obtained the user's authorization to use even if the first SDK calls up the first target payment application program, the first target payment application program thus cannot make the payment as usual. Only when the first target payment application program in the user terminal activates the multi-party payment function and the user is also logged into the first target payment application program, may the first target payment application program use the multi-party payment function to make the payment as usual.

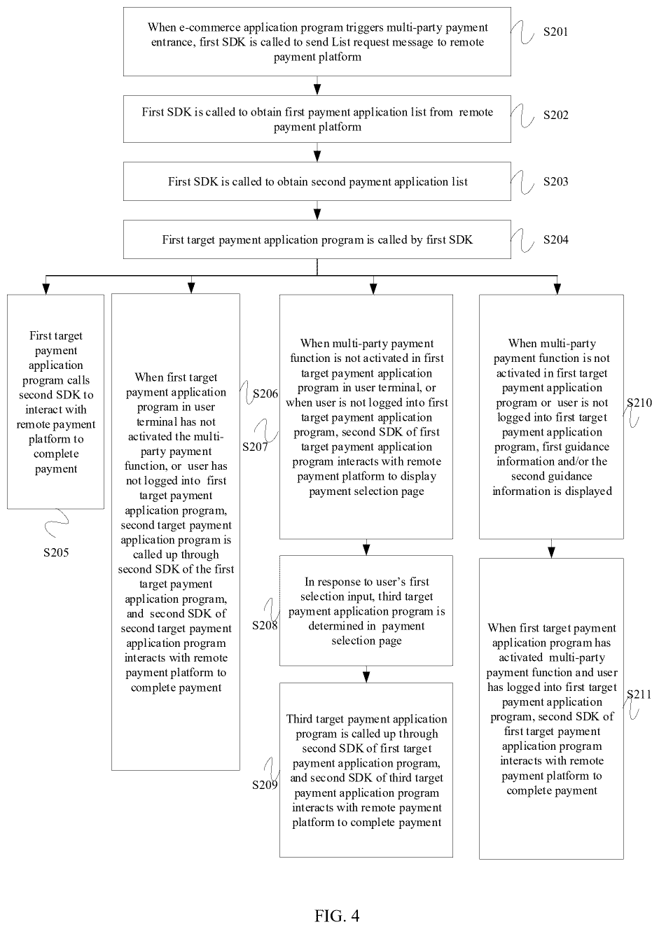

In some embodiments, when the multi-party payment function is not activated in the first target payment application program, or when the user is not logged into the first target payment application program, other measures may be taken to assist the user in making payment to improve the payment success rate. FIG. 4 is a flowchart of a smart routing-based remote payment method in accordance with another embodiment of the first aspect of the present disclosure. FIG. 4 differs from FIG. 2 in that the smart routing-based remote payment method shown in FIG. 4 may also include Step S206, or, include Steps S207 to S209, or, include Steps S210 and S211.

In Step S206, if the first target payment application program in the user terminal has not activated the multi-party payment function, or the user has not logged into the first target payment application program, a second target payment application program is called up through the second SDK of the first target payment application program, and the second SDK of the second target payment application program interacts with the remote payment platform to complete the payment.

When the first target payment application program in the user terminal has not activated the multi-party payment function, or the user has not logged into the first target payment application program, the first target payment application program cannot use the multi-party payment function to make the payment as usual. In order to improve the payment success rate, the second SDK of the first target payment application program may call up a second payment application program to continue the payment process. The second target payment application program is a designated payment application program or a payment application program with the second highest priority in the intersection of the first payment application list and the second payment application list. The designated payment application program may be one or more than one. When there are multiple designated payment application programs, the second target payment application program is any one of the designated payment application programs, or the one with the highest priority, which is not limited here. In some embodiments, the second target payment application program may include a payment application program designated by the first entity or the third entity. The payment application program with the second highest priority in the intersection of the first payment application list and the second payment application list is the payment application program with a priority only lower than the first target payment application program in the intersection of the first payment application list and the second payment application list. For example, in the intersection of the first payment application list and the second payment application list, the payment application programs are ranked in a descending order of priority as payment application program C2, payment application program C1, payment application program C4 and payment application program C3. Then, the first target payment application program is payment application program C2, and the second target payment application program is payment application program C1.

When the second target payment application program is called, the second SDK of the second target payment application program interacts with the remote payment platform to complete the payment. The specific content of the second SDK of the second target payment application program interacting with the remote payment platform to complete the payment is basically the same as the specific content of the second SDK of the first target payment application program interacting with the remote payment platform to complete the payment, detail of which will not be repeated here.

When the first target payment application program cannot use the multi-party payment function to make the payment as usual, the user terminal may automatically call up another payment application program in the user terminal, and interact with the remote platform through the second SDK of the other payment application program to complete the payment, thereby avoiding payment failure and improving the payment success rate. This process does not require manual operation by the user, which also improves the user's payment experience.

In Step S207, if the multi-party payment function is not activated in the first target payment application program in the user terminal, or if the user is not logged into the first target payment application program, the second SDK of the first target payment application program interacts with the remote payment platform to display the payment selection page.

If the first target payment application program in the user terminal has not activated the multi-party payment function, or if the user has not logged into the first target payment application program, the first target payment application program cannot normally use the multi-party payment function to make payments. In order to improve the payment success rate, the remote payment platform may provide a payment selection page to the second SDK of the first target payment application program, and the payment selection page includes the identifiers of the payment application programs, that have activated the multi-party payment function, for the user to select.

In Step S208, in response to a user's first selection input, a third target payment application program is determined in the payment selection page.

The first selection input is a user's selection input on the payment selection page. The first selection input may indicate an identifier of a payment application program in the payment selection page. The third target payment application program is the payment application program indicated by the first selection input in the payment selection page.

In Step S209, the third target payment application program is called up through the second SDK of the first target payment application program, and the second SDK of the third target payment application program interacts with the remote payment platform to complete the payment.

When the third target payment application program is called, the second SDK of the third target payment application program interacts with the remote payment platform to complete the payment. The specific content of the interaction between the second SDK of the third target payment application program and the remote payment platform to complete the payment is basically the same as the specific content of the interaction between the second SDK of the first target payment application program and the remote payment platform to complete the payment, which will not be repeated here.

In the event that the first target payment application program cannot use the multi-party payment function normally for payment, the remote payment platform may provide a payment selection page to the second SDK of the first target payment application program in the user terminal for the user to select a payment application program to be called up. The payment made by the payment application program selected by the user, i.e., the third target payment application program, is less likely to be canceled, which may further improve the success rate of payment.

In Step S210, when the multi-party payment function is not activated in the first target payment application program or the user is not logged into the first target payment application program, first guidance information and/or the second guidance information is displayed.

The first guidance information is used to guide the user to activate the multi-party payment function for the first target payment application program. In response to the user's input operation to the first guidance information, the user terminal interacts with the remote payment platform through the second SDK of the first target payment application program to activate the multi-party payment function of the first target payment application program in the user terminal.

The second guidance information is used to guide the user to log into the first target payment application program. The user terminal may interact with the backend system of the first target payment application program through the first target payment application program in response to the user's input operation to the second guidance information to enable the user to log into the first target payment application program.

In Step S211, when the first target payment application program has activated the multi-party payment function and the user has logged into the first target payment application program, the second SDK of the first target payment application program interacts with the remote payment platform to complete the payment.

When the first target payment application program has activated the multi-party payment function and the user has logged into the first target payment application program, the first target payment application program may use the multi-party payment function to make the payment normally, and the second SDK of the first target payment application program may be called to interact with the remote payment platform to complete the payment.

By guiding the user to activate the multi-party payment function of the first target payment application program in the user terminal and guiding the user to log into the first target payment application program, the payment may be completed through the second SDK of the first target payment application program, thus avoiding payment failure and improving the payment success rate.

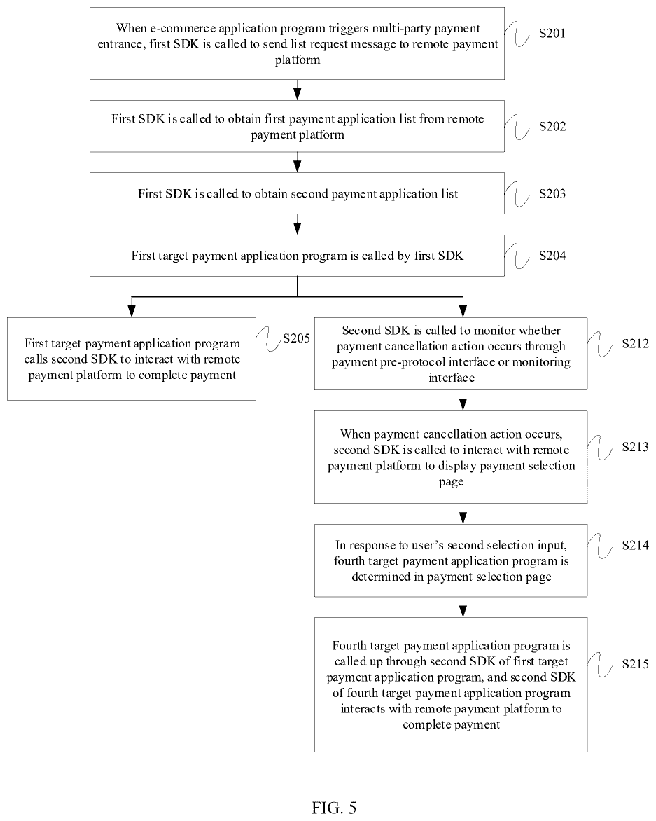

In some embodiments, payment cancellation may occur during a payment process, and payment cancellation may be caused by a variety of reasons. By providing a payment selection page, the user may confirm again whether to cancel the current payment to avoid payment failure caused by misoperation or program error. FIG. 5 is a flowchart of a smart routing-based remote payment method in accordance with another embodiment of the first aspect of the present disclosure. The difference between FIG. 5 and FIG. 2 is that the smart routing-based remote payment method shown in FIG. 5 may also include Steps S212 to S215.

In Step S212, the second SDK is called to monitor whether a payment cancellation action occurs through a payment pre-protocol interface or the monitoring interface.

A payment cancellation caused by user input or program error will generate a payment cancellation action. The second SDK may monitor the payment cancellation action through the payment pre-protocol interface or the monitoring interface. When the payment cancellation action occurs, the payment pre-protocol interface or the monitoring interface may receive a trigger instruction, and the second SDK of the first target payment application program may be called to execute Step S213 through the trigger instruction.

In Step S213, when a payment cancellation action occurs, the second SDK is called to interact with the remote payment platform to display a payment selection page.

The second SDK of the first target payment application program interacts with the remote payment platform, and obtains and displays a payment selection page from the remote payment platform. The payment selection page includes the identifier of the payment application program that has activated the multi-party payment function. The specific content of the payment selection page may be found in the relevant description in the above embodiments, which will not be repeated here.

In Step S214, in response to the user's second selection input, a fourth target payment application program is determined in the payment selection page.

The second selection input is the user's selection input for the payment selection page. The second selection input may indicate an identifier of a payment application program in the payment selection page. The fourth target payment application program is the payment application program indicated by the second selection input in the payment selection page.

In Step S215, the fourth target payment application program is called up through the second SDK of the first target payment application program, and the second SDK of the fourth target payment application program interacts with the remote payment platform to complete the payment.

When the fourth target payment application program is called, the second SDK of the fourth target payment application program interacts with the remote payment platform to complete the payment. The specific content of the second SDK of the fourth target payment application program interacting with the remote payment platform to complete the payment is basically the same as the specific content of the second SDK of the first target payment application program interacting with the remote payment platform to complete the payment, and will not be repeated here.

During the payment process, payment cancellation may occur. By providing a payment selection page to ask the user to confirm whether to cancel the payment and by offering an option for another payment application program, payment failure caused by misoperation or program error may be avoided and the payment success rate may be improved.

In some embodiments, in the above embodiments, if the multi-party payment function is not activated in the first target payment application program in the user terminal, or the user is not logged into the first target payment application program, etc., the payment pre-protocol interface or the monitoring interface may be called back to notify the first target payment application program so that the first target payment application program jumps to the corresponding multi-party payment function activation process, login process, etc. If the multi-party payment function is successfully activated in the multi-party payment function activation process and/or the login is successfully logged in during the login process, the first target payment application program will call back the second SDK, and the second SDK will continue the remote payment process. If the multi-party payment function fails to be activated in the multi-party payment function activation process and/or the login fails during the login process, the second SDK may also be called back, and the second SDK interacts with the remote payment platform to display the payment selection page.

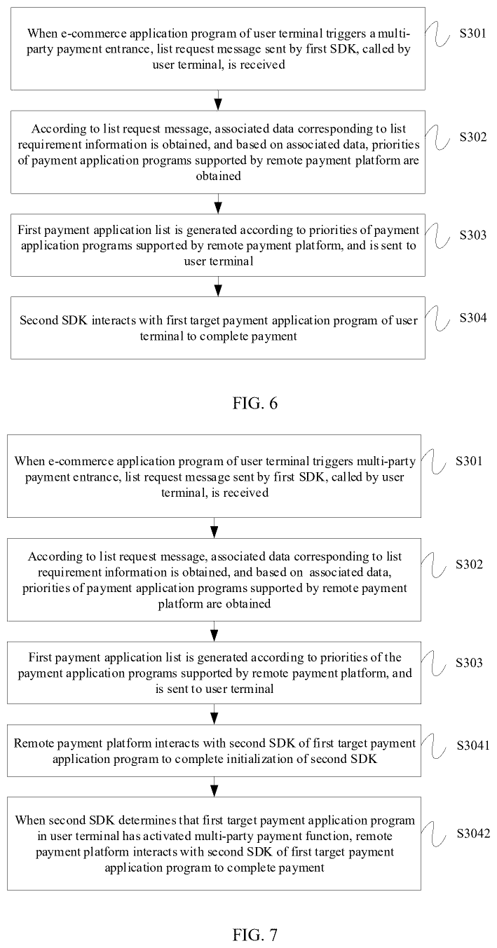

A second aspect of the present disclosure provides a smart routing-based remote payment method, which may be applied to a remote payment platform, that is, the smart routing-based remote payment method may be executed by the remote payment platform. FIG. 6 is a flowchart of a smart routing-based remote payment method in accordance with an embodiment of the second aspect of the present disclosure. As shown in FIG. 6, the smart routing-based remote payment method may include Steps S301 to S304.

In Step S301, when an e-commerce application program of a user terminal triggers a multi-party payment entrance, a list request message sent by a first SDK, called by the user terminal, is received.

The list request message includes list requirement information, where the list requirement information includes an e-commerce application identifier and a user identifier.

In some embodiments, the list requirement information may also include one or more of the following: the version of the user terminal operating system, the version of the first SDK, and the version of the second SDK.

The user terminal includes an e-commerce application program, a first SDK integrated in the e-commerce application program, a payment application program, and a second SDK integrated in the payment application program, where the e-commerce application program belongs to the first entity, the payment application program belongs to the second entity, and the first SDK and the second SDK belong to the third entity.

In Step S302, according to the list request message, associated data corresponding to the list requirement information is obtained, and based on the associated data, priorities of payment application programs supported by the remote payment platform are obtained.

Different list requirement information may correspond to different associated data, and different associated data may correspond to different priorities of payment application programs supported by the remote payment platform. The specific content of the list requirement information may be found in the relevant description in the above embodiments, which will not be repeated here.

In some embodiments, the associated data includes one or more of the following: payment frequency, payment success rate, payment resource amount, payment time of payment application program, user's payment credit limit in the payment application program, the call-up sequence of payment application programs specified by the first entity, and the call-up sequence of payment application programs specified by the third entity.

In Step S303, a first payment application list is generated according to the priorities of the payment application programs supported by the remote payment platform, and is sent to the user terminal.

The first payment application list represents a plurality of payment application programs supported by the remote payment platform, which are ranked in a descending order of priority.

In Step S304, the second SDK interacts with a first target payment application program of the user terminal to complete the payment.

The first target payment application program is a payment application program with the highest priority in the intersection of the first payment application list and the second payment application list. The second payment application list represents the payment application programs owned by the user terminal.

The specific contents of Step S301 to Step S304 may be found in the relevant descriptions in the above embodiments, which will not be repeated here.

In the embodiments of the present disclosure, when the e-commerce application program of the user terminal triggers a multi-party payment entrance, the remote payment platform interacts with the first SDK integrated in the e-commerce application program, obtains the list requirement information from the first SDK, and, based on the list requirement information, provides the first SDK with a list of multiple payment application programs, supported by the remote payment platform, ranked from high to low, corresponding to the list requirement information. Through the payment application programs locally presented in the user terminal and the multiple payment application programs, supported by the remote payment platform in a descending order of priority, provided by the remote payment platform, the first SDK determines a local payment application program with the highest priority and automatically calls it up without the need for the user to manually select the payment application program. The remote payment platform interacts with the second SDK of the local payment application program with the highest priority automatically called up by the user terminal (i.e., a first target payment application program) to complete the payment. In the remote payment process, the user does not need to manually select the payment application program, and the user terminal may automatically call up the payment application program that is compatible with the e-commerce application program and the user to make the payment, thereby improving the payment efficiency.

In addition, the remote payment platform provides a first payment application list representing payment application programs ranked in a descending order of priority, so that the first SDK in the user terminal may automatically call up a local payment application program with the highest priority for payment. Without the need for the user to perform a payment application program selection operation, the payment application program with the highest priority is actively called up for the user. The payment application program recommendation process is a smart routing process, which achieves accurate and reasonable recommendation of the payment application program, that is, achieves accurate and reasonable automatic selection of the payment method.

Moreover, the first SDK belonging to the third entity is integrated into the e-commerce application program belonging to the first entity, and the second SDK belonging to the third entity is integrated into the payment application program belonging to the second entity, so that the e-commerce application program and multiple payment application programs may access the remote payment platform belonging to the third entity, achieving the multi-party payment function. It can be seen that the multi-party payment function enables multiple payment application programs to access the same remote payment platform, achieves the online platform sharing of multiple payment application programs, optimizes the remote-control payment process, shortens the user payment operation path, and improves the user experience.

In some embodiments, the second entity to which the first target payment application program belongs authorizes the first target payment application program to have the permission to activate the multi-party payment function, but the first target payment application program in the user terminal may not have activated the multi-party payment function. Therefore, during the payment process, it is necessary to check whether the first target payment application program in the user terminal has activated the multi-party payment function. FIG. 7 is a flowchart of a smart routing-based remote payment method in accordance with another embodiment of the second aspect of the present disclosure. The difference between FIG. 7 and FIG. 6 is that Step S304 in FIG. 6 may be specifically refined into Step S3041 and Step S3042 in FIG. 7.

In Step S3041, the remote payment platform interacts with the second SDK of the first target payment application program to complete the initialization of the second SDK.

In Step S3042, when the second SDK determines that the first target payment application program in the user terminal has activated the multi-party payment function, the remote payment platform interacts with the second SDK of the first target payment application program to complete the payment.

In some embodiments, the remote payment platform may also interact with the second SDK of the first target payment application program to complete the payment when the first target payment application program is logged in. That is, when the second SDK determines that the first target payment application program in the user terminal has activated the multi-party payment function and the user has logged into the first target payment application program, the remote payment platform may interact with the second SDK of the first target payment application program to complete the payment.

The specific contents of the above Step S3041 and Step S3042 may be found in the relevant descriptions in the above embodiments, which will not be repeated here.

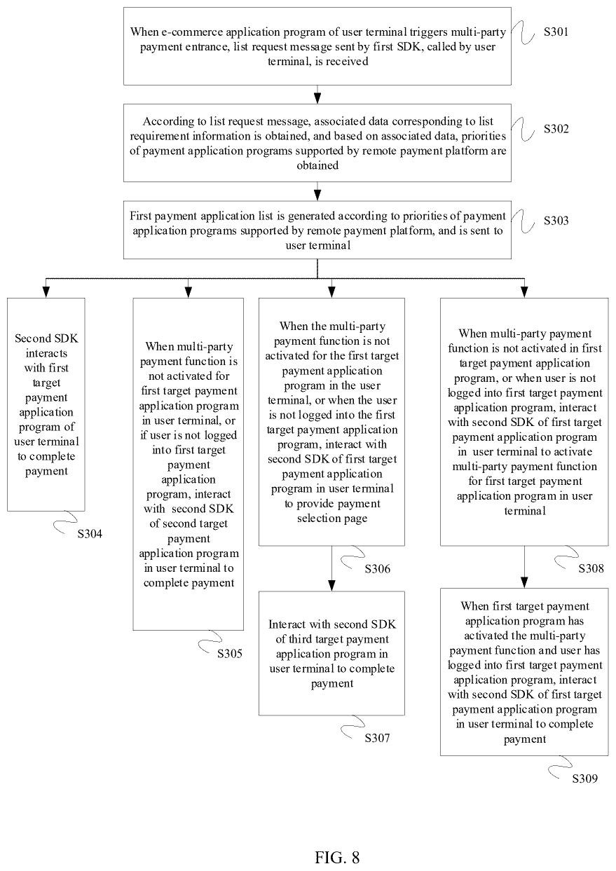

In some embodiments, when the multi-party payment function is not activated in the first target payment application program, or when the user is not logged into the first target payment application program, other measures may be taken to assist the user in making payment to improve the payment success rate. FIG. 8 is a flowchart of a smart routing-based remote payment method in accordance with another embodiment of the second aspect of the present disclosure. FIG. 8 differs from FIG. 6 in that the smart routing-based remote payment method shown in FIG. 8 may also include Step S305, or, include Steps S306 and S307, or, include Steps S308 and S309.

In Step S305, if the multi-party payment function is not activated for the first target payment application program in the user terminal, or if the user is not logged into the first target payment application program, the remote payment platform interacts with the second SDK of a second target payment application program in the user terminal to complete the payment.

The second target payment application program is a designated payment application program or a payment application program with a second highest priority in the intersection of the first payment application list and the second payment application list.

In Step S306, when the multi-party payment function is not activated for the first target payment application program in the user terminal, or when the user is not logged into the first target payment application program, the remote payment platform interacts with the second SDK of the first target payment application program in the user terminal to provide a payment selection page.

The payment selection page includes the identifier of the payment application program that has activated the multi-party payment function.

In Step S307, the remote payment platform interacts with the second SDK of a third target payment application program in the user terminal to complete the payment.

The third target payment application program includes a payment application program determined in a payment selection page by the user terminal in response to a user's first selection input.

In Step S308, when the multi-party payment function is not activated in the first target payment application program, or when the user is not logged into the first target payment application program, the remote payment platform interacts with the second SDK of the first target payment application program in the user terminal to activate the multi-party payment function for the first target payment application program in the user terminal.

In Step S309, when the first target payment application program has activated the multi-party payment function and the user has logged into the first target payment application program, the remote payment platform interacts with the second SDK of the first target payment application program in the user terminal to complete the payment.

The specific contents of the above Steps S305 to S309 may be found in the relevant descriptions in the above embodiments, which will not be repeated here.

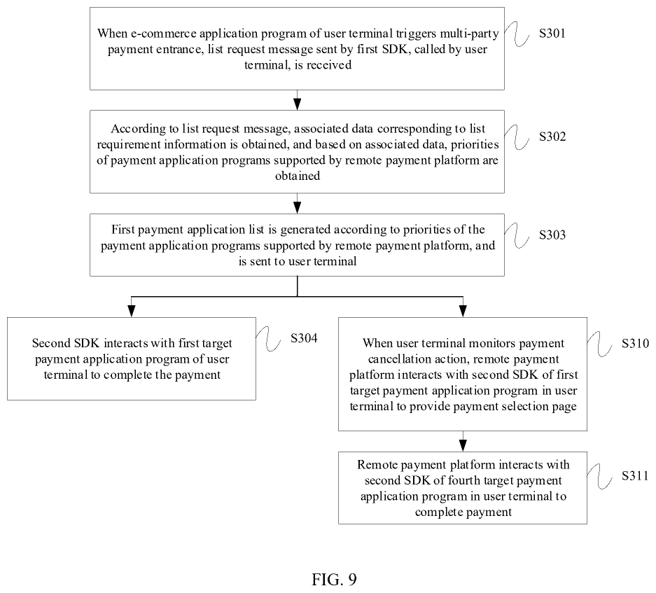

In some embodiments, payment cancellation may occur during the payment process, and payment cancellation may be caused by a variety of reasons. By providing a payment selection page, the user may confirm again whether to cancel the current payment to avoid payment failure caused by misoperation or program error. FIG. 9 is a flowchart of a smart routing-based remote payment method in accordance with another embodiment of the second aspect of the present disclosure. The difference between FIG. 9 and FIG. 6 is that the smart routing-based remote payment method shown in FIG. 9 may also include Step S310 and Step S311.

In Step S310, when the user terminal monitors a payment cancellation action, the remote payment platform interacts with the second SDK of the first target payment application program in the user terminal to provide a payment selection page.

The payment selection page includes the identifier of the payment application program that has activated the multi-party payment function.

In Step S311, the remote payment platform interacts with the second SDK of a fourth target payment application program in the user terminal to complete the payment.

The fourth target payment application program includes a payment application program determined by the user terminal in the payment selection page in response to a user's second selection input.

The specific contents of the above Step S310 and Step S311 may be found in the relevant descriptions in the above embodiments, which will not be repeated here.

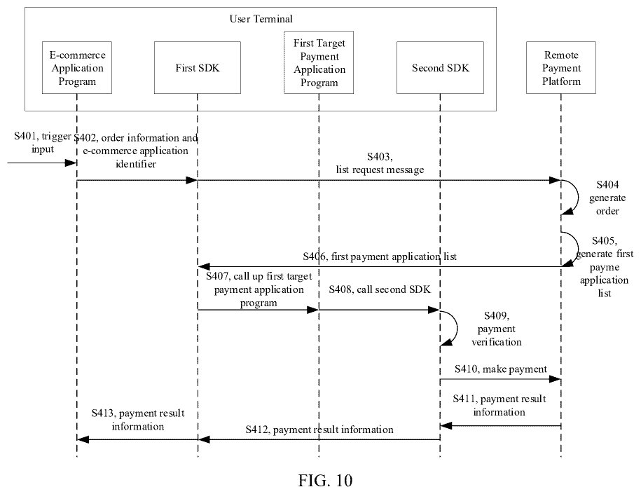

For ease of understanding, in the next, the process of calling up the first target payment application program and making payment in the above embodiments will be described in view of the interaction between the e-commerce application program, the first SDK, the payment application program, the second SDK, and the remote payment platform. FIG. 10 is a flowchart of an example of the remote payment process in accordance with the embodiment of the present disclosure. As shown in FIG. 10, the remote payment process may include Steps S401 to S413.

In Step S401, the e-commerce application program in the user terminal receives a trigger input from the user for a multi-party payment entrance.

In Step S402, in response to the trigger input, the e-commerce application program sends order information and an e-commerce application identifier to the first SDK.

In Step S403, the first SDK sends a list request message to the remote payment platform. The list request message may include list requirement information and the order information.

In Step S404, the remote payment platform generates an order according to the list request message.

In Step S405, the remote payment platform obtains associated data corresponding to the list requirement information according to the list requirement information, obtains the priorities of payment application programs supported by the remote payment platform based on the associated data, and generates a first payment application list.

In Step S406, the remote payment platform sends the first payment application list to the first SDK.

In Step S407, the first SDK obtains a second payment application list from the user terminal, and calls up a first target payment application program according to the first payment application list and the second payment application list.

In Step S408, the first target payment application program calls the second SDK of the first target payment application program.

In Step S409, the second SDK requests payment verification from the user.

In Step S410, when the payment verification is passed, the second SDK interacts with the remote payment platform to make the payment.

In Step S411, the remote payment platform obtains payment result information and sends the payment result information to the second SDK.

In Step S412, the second SDK sends the payment result information to the first SDK.

In Step S413, the first SDK sends the payment result information to the e-commerce application program.

The specific contents of the above Steps S401 to S413 may be found in the relevant descriptions in the above embodiments, which will not be repeated here.

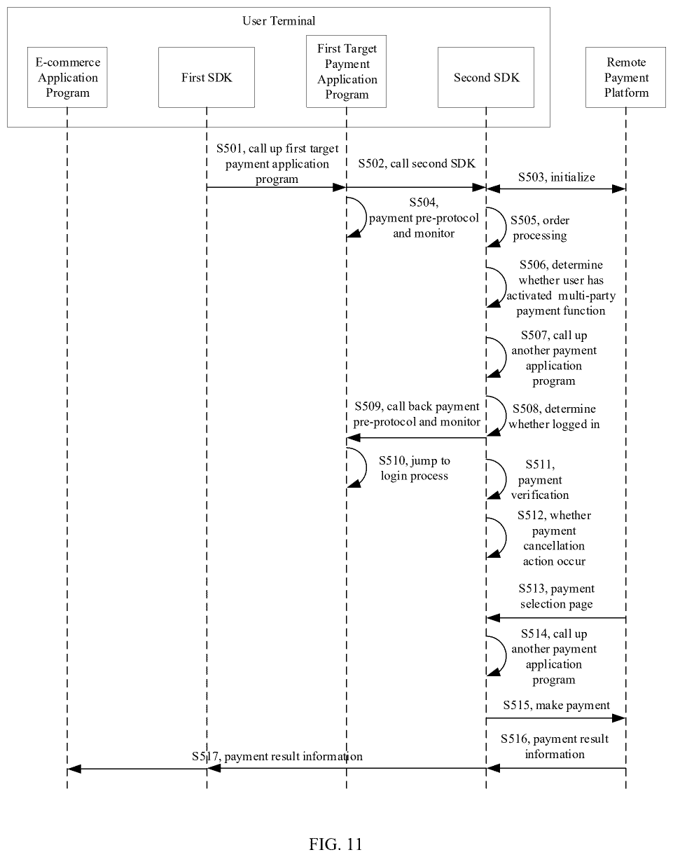

In the above remote payment process, it is also necessary to initialize the second SDK, detect whether the first target payment application program in the user terminal has activated the multi-party payment function, and whether the user is logged in. The remote payment process may be explained in view of the interaction between the e-commerce application program, the first SDK, the payment application program, the second SDK, and the remote payment platform as follows. The content of how the first target payment application program is specifically called up in the above example is omitted in this example. FIG. 11 is a flowchart of another example of the remote payment process in accordance with an embodiment of the present disclosure. As shown in FIG. 11, the remote payment process may include Steps S501 to S517.

In Step S501, in response to a user's trigger input to a multi-party payment entrance of the e-commerce application program, the user terminal calls a first target payment application program using the first SDK.

In Step S502, the first target payment application program calls the second SDK of the first target payment application program.

In Step S503, the second SDK interacts with the remote payment platform to complete the initialization of the second SDK.

In Step S504, the first target payment application program implements a pre-payment protocol and monitoring.

In Step S505, the second SDK performs order processing.

In Step S506, the second SDK determines whether the user has activated the multi-party payment function in the first target payment application program. If the multi-party payment function has not been activated, jump to Step S507; if the multi-party payment function has been activated, jump to Step S508.

In Step S507, the second SDK calls up another payment application program in the user terminal that has a multi-party payment function activated, so as to make the payment using the other payment application program.

In Step S508, the second SDK determines whether the user has logged into the first target payment application program. If the user is not logged in, jump to Step S509; if the user is logged in, jump to Step S511.

In Step S509, the second SDK calls back to the payment pre-protocol and monitoring to notify the first target payment application program.

In Step S510, the first target payment application program jumps to the login process. If the login is successful in the login process, jump to Step S511; if the login fails in the login process, jump to Step S515.

In Step S511, the second SDK performs payment verification.

In Step S512, the second SDK detects whether a payment cancellation action occurs. If a payment cancellation action occurs, jump to Step S513; if no payment cancellation action occurs, jump to Step S515.

In Step S513, the second SDK interacts with the remote payment platform to obtain and display a payment selection page.

In Step S514, in response to a user's selection input, the second SDK calls up another payment application program in the user terminal to make the payment using the other payment application program.

In Step S515, the second SDK interacts with the remote payment platform to make the payment.

In Step S516, the remote payment platform sends payment result information to the second SDK.

In Step S517, the second SDK sends the payment result information to the e-commerce application program through the first SDK.

The specific contents of the above Steps S501 to S517 may be found in the relevant descriptions in the above embodiments, which will not be repeated here.

A third aspect of the present disclosure provides a user terminal, which may specifically be the user terminal in the above embodiments. The user terminal includes an e-commerce application program, a first SDK integrated in the e-commerce application program, a payment application program, and a second SDK integrated in the payment application program. The e-commerce application program belongs to the first entity, the payment application program belongs to the second entity, and the first SDK and the second SDK belong to the third entity. FIG. 12 is a schematic structure diagram of a user terminal in accordance with an embodiment of the third aspect of the present disclosure. As shown in FIG. 12, the user terminal 600 may include a communication module 601 and a processing module 602.

Communication module 601 may be configured, when an e-commerce application program triggers a multi-party payment entrance, to be called by the first SDK to send a list request message to a remote payment platform, the list request message includes list requirement information, where the list requirement information includes an e-commerce application identifier and a user identifier; and to be called by the first SDK to obtain a first payment application list from the remote payment platform, the first payment application list represents multiple payment application programs supported by the remote payment platform, ranked in a descending order of priority, the priority being obtained by the remote payment platform based on the associated data corresponding to the list requirement information.

In some embodiments, the list requirement information also includes one or more of the following: the version of the user terminal operating system, the version of the first SDK, and the version of the second SDK.

In some embodiments, the associated data includes one or more of the following: payment frequency, payment success rate, payment resource amount, payment time of payment application program, and user's payment credit limit in the payment application program, the call-up sequence of payment application programs specified by the first entity, and the call-up sequence of payment application programs specified by the third entity.

Processing module 602 may be configured to be called by the first SDK to obtain a second payment application list, where the second payment application list represents the payment application programs owned by the user terminal; call the first SDK to call up a first target payment application, where the first target payment application program is the payment application program with the highest priority in the intersection of the first payment application list and the second payment application list.

The communication module 601 may also be configured to be called by the second SDK of the first target payment application program to interact with the remote payment platform to complete the payment.

In the embodiments of the present disclosure, when the e-commerce application program triggers a multi-party payment entrance, the user terminal uses the first SDK integrated in the e-commerce application program to interact with the remote payment platform and provide the remote payment platform with list requirement information, so that the remote payment platform provides a list of multiple payment application programs supported by the remote payment platform in a descending order of priority corresponding to the list requirement information. Through the payment application programs locally presented in the user terminal and the multiple payment application programs, supported by the remote payment platform in a descending order of priority, provided by the remote payment platform, the first SDK determines a local payment application program with the highest priority and automatically calls it up without the need for the user to manually select the payment application program. The automatically called local payment application program with the highest priority, i.e., the first target payment application program, may call the second SDK to interact with the remote payment platform to complete the payment. In the remote payment process, the user does not need to manually select the payment application program, and the payment application program adapted to the e-commerce application program and the user may be automatically called up for payment, thereby improving the payment efficiency.

Moreover, the multi-party payment function enables multiple payment application programs to access the same remote payment platform, achieves the online platform sharing of multiple payment application programs, optimizes the remote-control payment process, shortens the user payment operation path, and improves the user experience.

In some embodiments, the processing module 602 may be configured to be called by the second SDK to query the multi-party payment function activation sign bit stored locally to determine whether the first target payment application program in the user terminal has activated the multi-party payment function.

The communication module 601 may be configured to be called by the second SDK to interact with the remote payment platform to complete the payment when the first target payment application program in the user terminal activates the multi-party payment function.

In some embodiments, the processing module 602 may be configured to be called by the second SDK to determine whether the user has logged into the first target payment application program when the first target payment application program in the user terminal activates the multi-party payment function.

The communication module 601 may be configured to be called by the second SDK to interact with the remote payment platform to complete the payment when the user has logged into the first target payment application program.

In some embodiments, the communication module 601 may also be configured to be called by the second SDK of the first target payment application program to interact with the remote payment platform to complete the initialization of the second SDK.

In some embodiments, for a situation when the first target payment application program in the user terminal has not activated the multi-party payment function, or the user has not logged into the first target payment application program, and the second SDK of the first target payment application program calls up the second target payment application program, the communication module 601 may also be configured to be called by the second SDK of the second target payment application program to interact with the remote payment platform to complete the payment.

The second target payment application program is a designated payment application program or a payment application program with a second highest priority in the intersection of the first payment application list and the second payment application list.

In some embodiments, the user terminal may further include a display module.

The communication module 601 may also be configured to be called by the second SDK of the first target payment application program to interact with the remote payment platform to obtain a payment selection page, when the multi-party payment function is not activated in the first target payment application program in the user terminal, or when the user is not logged into the first target payment application program.

The display module may be configured to display the payment selection page.

The payment selection page includes the identifier of the payment application program that has activated the multi-party payment function.

The processing module 602 may also be configured to determine a third target payment application program in the payment selection page in response to the user's first selection input.

The communication module 601 may also be configured to, when the third target payment application program is called by the second SDK of the first target payment application program, be called by the second SDK of the third target payment application program to interact with the remote payment platform to complete the payment.

In some embodiments, the user terminal may further include a display module.

The display module may be configured to display first guidance information and/or second guidance information when the multi-party payment function is not activated in the first target payment application program or the user is not logged into the first target payment application program.

The first guidance information is used to guide the user to activate the multi-party payment function for the first target payment application program. The second guidance information is used to guide the user to log into the first target payment application program.

The communication module 601 may also be configured to be called by the second SDK of the first target payment application program to interact with the remote payment platform to complete the payment, when the multi-party payment function is activated in the first target payment application program and the user has logged into the first target payment application program.

In some embodiments, the user terminal may further include a display module.

The processing module 602 may also be configured to call the second SDK to monitor whether a payment cancellation action occurs through a payment pre-protocol interface or a monitoring interface.

The communication module 601 may also be configured to be called by the second SDK to interact with the remote payment platform and obtain a payment selection page when a payment cancellation action occurs.

The display module may be configured to display the payment selection page.

The payment selection page includes the identifier of the payment application program that has activated the multi-party payment function.

The processing module 602 may also be configured to determine a fourth target payment application program in the payment selection page in response to a second selection input by the user.

The communication module 601 may also be configured to be called by the second SDK of the fourth target payment application program to interact with the remote payment platform to complete the payment when the fourth target payment application program is called by the second SDK of the first target payment application program.

In some embodiments, the processing module 602 may be configured to be called by the first SDK to send a call-up message to the first target payment application program, control the first target payment application program to start in response to the call-up message, and directly jump to a page indicated by the call-up message.

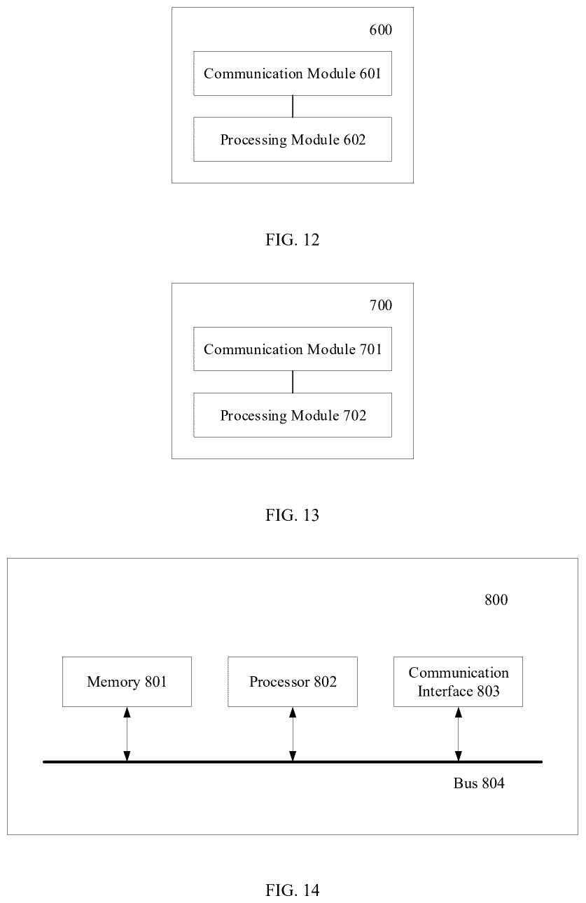

A fourth aspect of the present disclosure provides a smart routing-based remote payment apparatus, which may be applied to a remote payment platform. The specific content of the remote payment platform may be found in the relevant descriptions in the above embodiments, which will not be repeated here. FIG. 13 is a schematic structure diagram of a smart routing-based remote payment apparatus in accordance with an embodiment of the fourth aspect of the present disclosure. As shown in FIG. 13, the smart routing-based remote payment apparatus 700 may include a communication module 701 and a processing module 702.

The communication module 701 may be configured to receive a list request message sent the first SDK called by a user terminal when an e-commerce application program of the user terminal triggers a multi-party payment entrance.

The list request message includes list requirement information, where the list requirement information includes an e-commerce application identifier and a user identifier.

In some embodiments, the list requirement information also includes one or more of the following: the version of the user terminal operating system, the version of the first SDK, and the version of the second SDK.

The user terminal includes an e-commerce application program, a first SDK integrated in the e-commerce application program, a payment application program, and a second SDK integrated in the payment application program. The e-commerce application program belongs to the first entity, the payment application program belongs to the second entity, and the first SDK and the second SDK belong to the third entity.

Processing module 702 may be configured to obtain the associated data corresponding to the list requirement information according to the list request message, and obtain the priorities of the payment application programs supported by the remote payment platform based on the associated data; and to generate a first payment application list according to the priorities of the payment application programs supported by the remote payment platform.

The first payment application list represents a plurality of payment application programs supported by the remote payment platform, which are ranked in a descending order of priority.

In some embodiments, the associated data includes one or more of the following: payment frequency, payment success rate, payment resource amount, payment time of payment application program, the user's payment credit limit in the payment application program, the call-up sequence of payment application programs specified by the first entity, and the call-up sequence of payment application programs specified by the third entity.

The communication module 701 may also be configured to send the first payment application list to the user terminal, and to interact with a second SDK of a first target payment application program of the user terminal to complete the payment.

The first target payment application program is a payment application program with the highest priority in the intersection of the first payment application list and the second payment application list. The second payment application list represents the payment application programs owned by the user terminal.

In the embodiments of the present disclosure, when the e-commerce application program of the user terminal triggers a multi-party payment entrance, the remote payment platform interacts with the first SDK integrated in the e-commerce application program, obtains the list requirement information from the first SDK, and, based on the list requirement information, provides the first SDK with a list of multiple payment application programs, supported by the remote payment platform, ranked from high to low, corresponding to the list requirement information. Through the payment application programs locally presented in the user terminal and the multiple payment application programs, supported by the remote payment platform in a descending order of priority, provided by the remote payment platform, the first SDK determines a local payment application program with the highest priority and automatically calls it up without the need for the user to manually select the payment application program. The remote payment platform interacts with the second SDK of the local payment application program with the highest priority automatically called up by the user terminal (i.e., a first target payment application program) to complete the payment. In the remote payment process, the user does not need to manually select the payment application program, and the user terminal may automatically call up the payment application program that is compatible with the e-commerce application program and the user to make the payment, thereby improving the payment efficiency.

Moreover, the multi-party payment function enables multiple payment application programs to access the same remote payment platform, achieves the online platform sharing of multiple payment application programs, optimizes the remote-control payment process, shortens the user payment operation path, and improves the user experience.

In some embodiments, the communication module 701 may be configured to interact with the second SDK of the first target payment application program to complete the payment when the second SDK determines that the first target payment application program in the user terminal has activated the multi-party payment function.

In some embodiments, when the user has logged into the first target payment application program, the communication module 701 interacts with the second SDK of the first target payment application program to complete the payment.

In some embodiments, the communication module 701 may also be configured to interact with a second SDK of the first target payment application program to complete the initialization of the second SDK.

In some embodiments, the communication module 701 may also be configured to interact with the second SDK of the second target payment application program in the user terminal to complete payment when the multi-party payment function is not activated in the first target payment application program in the user terminal, or when the user is not logged into the first target payment application program.

The second target payment application program is a designated payment application program or a payment application program with a second highest priority in the intersection of the first payment application list and the second payment application list.

In some embodiments, the communication module 701 may also be configured to interact with the second SDK of the first target payment application program in the user terminal to provide a payment selection page when the multi-party payment function is not activated for the first target payment application program in the user terminal, or when the user is not logged into the first target payment application program; and to interact with the second SDK of the third target payment application program in the user terminal to complete the payment.

The payment selection page includes the identifier of the payment application program that has activated the multi-party payment function. The third target payment application program includes the payment application program determined in the payment selection page by the user terminal in response to the user's first selection input.

In some embodiments, the communication module 701 may also be configured to interact with the second SDK of the first target payment application program in the user terminal to activate the multi-party payment function for the first target payment application program in the user terminal when the multi-party payment function is not activated in the first target payment application program or when the user is not logged into the first target payment application program; and to interact with the second SDK of the first target payment application program in the user terminal to complete the payment when the multi-party payment function is activated in the first target payment application program and the user has logged into the first target payment application program.

In some embodiments, the communication module 701 may also be configured to interact with the second SDK of the first target payment application program in the user terminal to provide a payment selection page when the user terminal monitors a payment cancellation action; and to interact with the second SDK of the fourth target payment application program in the user terminal to complete the payment.

The payment selection page includes an identifier of a payment application program that has activated the multi-party payment function. The fourth target payment application program includes a payment application program determined in the payment selection page by the user terminal in response to the user's second selection input.

The fifth aspect of the present disclosure also provides a user terminal. FIG. 14 is a schematic structure diagram of a user terminal in accordance with an embodiment of the fifth aspect of the present disclosure. As shown in FIG. 14, the user terminal 800 includes a memory 801, a processor 802, and a computer program stored in the memory 801 and executable on the processor 802.

In an example, the processor 802 may include a central processing unit (CPU), or an application specific integrated circuit (ASIC), or may be configured to implement one or more integrated circuits of the embodiments of the present disclosure.

The memory 801 may include a read-only memory (ROM), a random-access memory (RAM), a magnetic disk storage medium device, an optical storage medium device, a flash memory device, an electrical, optical or other physical/tangible memory storage device. Therefore, generally, the memory includes one or more tangible (non-transitory) computer-readable storage media (e.g., a memory device) encoded with software including computer executable instructions, and when the software is executed (e.g., by one or more processors), it is operable to perform the operations described with reference to the smart routing-based remote payment methods in the embodiments of the first aspect of the present disclosure.

The processor 802 runs a computer program corresponding to the executable program code by reading the executable program code stored in the memory 801, so as to implement the smart routing-based remote payment methods in the embodiments of the first aspect of the present disclosure.

In some embodiments, the user terminal 800 may further include a communication interface 803 and a bus 804. As shown in FIG. 14, the memory 801, the processor 802, and the communication interface 803 are connected via the bus 804 and communicate with each other.

The communication interface 803 is mainly configured to achieve the communication between the modules, apparatus, units and/or device in the embodiments of the present disclosure. The communication interface 803 may also be configured to access input device and/or output device.

The bus 804 includes a hardware, a software or both, coupling the components of the user terminal 800 to each other. By way of example and not limitation, the bus 804 may include an Accelerated Graphics Port (AGP) or other graphics bus, an Enhanced Industry Standard Architecture (EISA) bus, a Front Side Bus (FSB), a Hyper Transport (HT) interconnect, an Industry Standard Architecture (ISA) bus, an infinite bandwidth interconnection, a Low Pin Count (LPC) bus, a memory bus, a Micro Channel Architecture (MCA) bus, a Peripheral Component Interconnect (PCI) bus, a PCI-Express (PCI-E) bus, a Serial Advanced Technology Attachment (SATA) bus, a Video electronics standards association Local Bus (VLB) bus, or other suitable buses or a combination of two or more of these. Where appropriate, the bus 804 may include one or more buses. Although embodiments of the present disclosure describe and illustrate a particular bus, the present disclosure accepts any suitable bus or interconnect.

The sixth aspect of the present disclosure further provides an electronic device, the electronic device may include a memory, a processor, and a computer program stored in the memory and executable on the processor.

The memory includes one or more tangible (non-transitory) computer-readable storage media (e.g., memory device) encoded with software including computer-executable instructions, and when the software is executed (e.g., by one or more processors), it is operable to perform the operations described with reference to the smart routing-based remote payment methods in the embodiments of the second aspect of the present disclosure.

The processor runs a computer program corresponding to the executable program code by reading the executable program code stored in the memory, so as to implement the smart routing-based remote payment methods in the embodiments of the second aspect of the present disclosure.

In some embodiments, the electronic devices may further include a communication interface and a bus. The memory, the processor, and the communication interface may be connected via the bus and communicate with each other.

The connection between the memory 801, processor 802, communication interface 803 and bus 804, and all the implementations may be found in the relevant descriptions in the above embodiments, which will not be repeated here.

The seventh aspect of the present disclosure further provides a remote payment system, and the remote payment system may include the user terminal and the remote payment platform in the above embodiments.

The user terminal includes an e-commerce application program, a first SDK integrated in the e-commerce application program, a payment application program, and a second SDK integrated in the payment application program. The e-commerce application program belongs to the first entity, the payment application program belongs to the second entity, and the first SDK and the second SDK belong to the third entity. The user terminal is configured to execute the smart routing-based remote payment methods in the embodiments of the first aspect of the present disclosure.

The remote payment platform may be configured to execute the smart routing-based remote payment methods in the embodiments of the second aspect of the present disclosure.

The specific contents of the user terminal, the remote payment platform, and the smart routing-based remote payment method may be found in the relevant descriptions in the above embodiments, which will not be repeated here.

The eighth aspect of the present disclosure also provides a computer-readable storage medium. Computer program instructions are stored on the computer-readable storage medium. When the computer program instructions are executed by the processor, the smart routing-based remote payment methods in the embodiments of the first aspect of the present disclosure or the smart routing-based remote payment methods in the embodiments of the second aspect of the present disclosure may be implemented, and the same technical effect may be achieved. To avoid repetition, these descriptions will not be repeated here. Here, the computer-readable storage medium may include non-transitory computer-readable storage mediums, such as ROM, RAM, magnetic disks or optical disks, etc., which are not limited here.

The present disclosure embodiment may also provide a computer program product. When the instructions in the computer program product are executed by a processor of an electronic device, the electronic device executes the smart routing-based remote payment methods in the embodiments of the first aspect of the present disclosure or the smart routing-based remote payment methods in the embodiments of the second aspect of the present disclosure, and may achieve the same technical effect, which will not be repeated here.

It should be noted that each embodiment in this specification is described in a progressive manner, where the same or similar parts between the various embodiments may be referred to each other. Each embodiment focuses on its differences from other embodiments. For user terminal embodiments, apparatus embodiments, device embodiments, system embodiments, computer-readable storage medium embodiments, and computer program product embodiments, relevant information may be found in the description of the method embodiments. The present disclosure is not limited to the specific steps and structures described above and illustrated in the drawings. Those skilled in the art may make various changes, modifications and additions, or change the order between the steps after understanding the spirit of the present disclosure. In addition, for the sake of brevity, detailed descriptions of known method technologies are omitted here.

Aspects of the present disclosure are described with references to flowchart illustrations and/or block diagrams of the methods, apparatus (systems) and computer program products according to the embodiments of the present disclosure. It will be understood that each block of the flowchart illustrations and/or block diagram, and the combination of blocks in the flowchart illustrations and/or block diagrams, may be implemented by computer program instructions. These computer program instructions may be provided to a processor of a general-purpose computer, a special-purpose computer, or other programmable data processing apparatus to produce a machine so that the execution of these instructions via the processor of the computer or other programmable data processing apparatus enables the implementation of the functions/actions specified in one or more blocks of the flowchart and/or block diagram. Such a processor may be, but is not limited to, a general-purpose processor, a special-purpose processor, a special application processor, or a field programmable logic circuit. It may also be understood that each block in the block diagram and/or flowchart illustrations, and the combination of blocks in the block diagram and/or flowchart illustrations may also be implemented by special purpose hardware that performs the specified functions or actions, or may be implemented by special purpose hardware and a combination of computer instructions.

Those skilled in the art should understand that the above embodiments are illustrative rather than restrictive. Different technical features appearing in different embodiments may be combined to achieve beneficial effects. Those skilled in the art should be able to understand and implement other modified embodiments of this disclosure based on understanding of drawing, description and claims. In the claims, the term “comprising” does not exclude other apparatus or steps; the term “a” does not exclude a plurality and the terms “first” and “second” are used to indicate names rather than to indicate any specific order. Any reference signs in the claims shall not be constructed as limiting the scope. The functions of several parts appearing in the claims may be implemented by a single hardware or software module. The appearance of certain technical features in different dependent claims does not mean that these technical features cannot be combined to achieve beneficial effects.

1. A smart routing-based remote payment method, applied to a user terminal, wherein the user terminal includes an e-commerce application program, a first software development kit (SDK) integrated in the e-commerce application program, a payment application program, and a second SDK integrated in the payment application program, wherein the e-commerce application program belongs to a first entity, the payment application program belongs to a second entity, the first SDK and the second SDK belong to a third entity, and the method comprising:
when the e-commerce application program triggers a multi-party payment entrance, calling the first SDK to send a list request message to a remote payment platform, wherein the list request message includes list requirement information, wherein the list requirement information includes an e-commerce application identifier and a user identifier;
calling the first SDK to obtain a first payment application list from the remote payment platform, wherein the first payment application list represents a plurality of payment application programs supported by the remote payment platform and ranked in a descending order of priority, wherein the priority is obtained by the remote payment platform based on associated data corresponding to the list requirement information;
calling the first SDK to obtain a second payment application list, wherein the second payment application list represents payment application programs owned by the user terminal;
calling up, by the first SDK, a first target payment application program, wherein the first target payment application program is a payment application program with a highest priority in an intersection of the first payment application list and the second payment application list; and
interacting, through a second SDK called by the first target payment application program, with the remote payment platform to complete a payment.

2. The method according to claim 1, wherein the list requirement information further includes one or more of the following:
a version of a user terminal operating system, a version of the first SDK, and a version of the second SDK.

3. The method according to claim 1, wherein the associated data includes one or more of the following:
a payment frequency of a payment application program, a payment success rate of a payment application program, a payment resource amount of a payment application program, a payment time of a payment application program, a payment credit limit of a user in a payment application program, a call-up sequence of payment application programs specified by the first entity, and a call-up sequence of the payment application programs specified by the third entity.

4. The method according to claim 1, wherein interacting, by the second SDK called by the first target payment application program, with the remote payment platform to complete a payment comprises:
querying, by the second SDK, a locally stored multi-party payment function activation sign bit to determine whether the first target payment application program in the user terminal has activated a multi-party payment function; and
when the multi-party payment function is activated in the first target payment application program in the user terminal, interacting, by the second SDK, with the remote payment platform to complete the payment.

5. The method according to claim 4, wherein, before querying, by the second SDK, a locally stored multi-party payment function activation sign bit to determine whether the first target payment application program in the user terminal has activated the multi-party payment function, the method further comprises:
interacting, through the second SDK called by the first target payment application program, with the remote payment platform to complete an initialization of the second SDK.

6. The method according to claim 4, wherein, when the multi-party payment function is activated in the first target payment application program in the user terminal, interacting, by the second SDK, with the remote payment platform to complete the payment comprises:
when the first target payment application program in the user terminal activates the multi-party payment function, determining, by the second SDK, whether a user has logged into the first target payment application program; and
when the user has logged into the first target payment application program, interacting, by the second SDK, with the remote payment platform to complete the payment.

7. The method according to claim 6, further comprises:
when the first target payment application program in the user terminal has not activated the multi-party payment function or when the user has not logged into the first target payment application program, calling up a second target payment application program through the second SDK of the first target payment application program, wherein the second SDK of the second target payment application program interacts with the remote payment platform to complete the payment, and the second target payment application program is a designated payment application program or a payment application program with a second highest priority in the intersection of the first payment application list and the second payment application list; or
when the first target payment application program in the user terminal has not activated the multi-party payment function or when the user has not logged into the first target payment application program, interacting with the remote payment platform through the second SDK of the first target payment application program to display a payment selection page, wherein the payment selection page includes an identifier of a payment application program that has activated the multi-party payment function; in response to a user's first selection input, determining a third target payment application program in the payment selection page; and calling up the third target payment application program through the second SDK of the first target payment application program, so that a second SDK of the third target payment application program interacts with the remote payment platform to complete the payment; or
when the first target payment application program in the user terminal has not activated the multi-party payment function or when the user has not logged into the first target payment application program, displaying first guidance information and/or second guidance information, wherein the first guidance information is used to guide a user to activate the multi-party payment function for the first target payment application program, and the second guidance information is used to guide the user to log into the first target payment application program; and when the first target payment application program has activated the multi-party payment function and the user has logged into the first target payment application program, the second SDK of the first target payment application program interacting with the remote payment platform to complete the payment.

8. The method according to claim 1, further comprising:
calling the second SDK to monitor, through a payment pre-protocol interface or a monitoring interface, whether a payment cancellation action occurs;
when a payment cancellation action occurs, calling the second SDK to interact with the remote payment platform to display a payment selection page, wherein the payment selection page includes an identifier of a payment application program that has activated a multi-party payment function;
in response to a second selection input by a user, determining a fourth target payment application program in the payment selection page; and
calling up the fourth target payment application program through the second SDK of the first target payment application program, so that a second SDK of the fourth target payment application program interacts with the remote payment platform to complete the payment.

9. The method according to claim 1, wherein calling up, by the first SDK, a first target payment application program comprises:
sending, by the first SDK, a call-up message to the first target payment application program; and
in response to the call-up message, the first target payment application program starting and directly jumping to a page indicated by the call-up message.

10. A smart routing-based remote payment method, applied to a remote payment platform, the method comprising:
when an e-commerce application program of a user terminal triggers a multi-party payment entrance, receiving a list request message sent by a first software development kit (SDK) called by the user terminal, wherein the list request message includes list requirement information, wherein the list requirement information includes an e-commerce application identifier and a user identifier, the user terminal has the e-commerce application program, the first SDK integrated in the e-commerce application program, a payment application program, and a second SDK integrated in the payment application program, the e-commerce application program belongs to a first entity, the payment application program belongs to a second entity, and the first SDK and the second SDK belong to a third entity;
according to the list request message, obtaining associated data corresponding to the list requirement information, and based on the associated data, obtaining priorities of payment application programs supported by the remote payment platform;
according to the priorities of the payment application programs supported by the remote payment platform, generating and sending a first payment application list to the user terminal, wherein the first payment application list represents a plurality of payment application programs supported by the remote payment platform and ranked in a descending order of priority; and
interacting with a second SDK of a first target payment application program of the user terminal to complete a payment, wherein the first target payment application program is a payment application program with a highest priority in an intersection of the first payment application list and a second payment application list, and the second payment application list represents payment application programs owned by the user terminal.

11. The method according to claim 10, wherein the list requirement information further comprises one or more of the following:
a version of a user terminal operating system, a version of the first SDK, and a version of the second SDK.

12. The method according to claim 10, wherein the associated data includes one or more of the following:
a payment frequency of a payment application program, a payment success rate of a payment application program, a payment resource amount of a payment application program, a payment time of a payment application program, a payment credit limit of a user in a payment application program, a call-up sequence of payment application programs specified by the first entity, and a call-up sequence of the payment application programs specified by the third entity.

13. The method according to claim 10, wherein interacting with a second SDK of a first target payment application program of the user terminal to complete a payment comprises:
interacting with the second SDK of the first target payment application program to complete the payment, when the SDK determines that the first target payment application program in the user terminal has activated a multi-party payment function.

14. The method according to claim 13, wherein, before interacting with a second SDK of a first target payment application program of the user terminal to complete a payment, the method further comprises:
interacting with the second SDK of the first target payment application program to complete an initialization of the second SDK.

15. The method according to claim 13, wherein interacting with a second SDK of a first target payment application program of the user terminal to complete a payment comprises:
when a user has logged into the first target payment application program, interacting with the second SDK of the first target payment application program to complete the payment.

16. The method according to claim 15, further comprises:
when the first target payment application program in the user terminal has not activated the multi-party payment function or when the user has not logged into the first target payment application program, interacting with a second SDK of a second target payment application program in the user terminal to complete the payment, wherein the second target payment application program is a designated payment application program or a payment application program with a second highest priority in the intersection of the first payment application list and the second payment application list; or
when the first target payment application program in the user terminal has not activated the multi-party payment function or when the user has not logged into the first target payment application program, interacting the second SDK of the first target payment application program in the user terminal to provide a payment selection page, wherein the payment selection page includes an identifier of a payment application program that has activated the multi-party payment function; and interacting with a second SDK of a third target payment application program in the user terminal to complete payment, wherein the third target payment application program includes a payment application program determined by the user terminal in the payment selection page in response to a user's first selection input; or
when the first target payment application program in the user terminal has not activated the multi-party payment function or when the user has not logged into the first target payment application program, interacting with the second SDK of the first target payment application program in the user terminal to activate the multi-party payment function for the first target payment application program in the user terminal; when the multi-party payment function is activated for the first target payment application program and the user has logged into the first target payment application program, interacting with the second SDK of the first target payment application program in the user terminal to complete the payment.

17. The method according to claim 15, further comprises:
when the user terminal monitors a payment cancellation action, interacting with the second SDK of the first target payment application program in the user terminal to provide a payment selection page, wherein the payment selection page includes an identifier of a payment application program that has activated the multi-party payment function; and
interacting with a second SDK of a fourth target payment application program in the user terminal to complete the payment, wherein the fourth target payment application program includes a payment application program determined by the user terminal in the payment selection page in response to a user's second selection input.

18. A user terminal, the user terminal including an e-commerce application program, a first software development kit (SDK) integrated in the e-commerce application program, a payment application program, and a second SDK integrated in the payment application program, the e-commerce application program belonging to a first entity, the payment application program belonging to a second entity, and the first SDK and the second SDK belonging to a third entity, and the user terminal comprising:
a communication module, configured to be called by the first SDK to send a list request message to a remote payment platform when the e-commerce application program triggers a multi-party payment entrance, wherein the list request message includes list requirement information, wherein the list requirement information includes an e-commerce application identifier and a user identifier; and configured to be called by the first SDK to obtain a first payment application list from a remote payment platform, wherein the first payment application list represents a plurality of payment application programs supported by the remote payment platform and ranked in a descending order of priority, and the priority is obtained by the remote payment platform based on associated data corresponding to the list requirement information; and
a processing module, configured to be called by the first SDK to obtain a second payment application list, wherein the second payment application list represents payment application programs possessed by the user terminal; and configured to be called by the first SDK to call up a first target payment application program, wherein the first target payment application program is a payment application program with a highest priority in an intersection of the first payment application list and the second payment application list,
wherein the communication module is further configured to be called by a second SDK of the first target payment application program to interact with the remote payment platform to complete a payment.

19.-23. (canceled)

24. The user terminal according to claim 18, wherein the list requirement information further comprises one or more of the following:
a version of a user terminal operating system, a version of the first SDK, and a version of the second SDK.

25. The user terminal according to claim 18, wherein the associated data includes one or more of the following:
a payment frequency of a payment application program, a payment success rate of a payment application program, a payment resource amount of a payment application program, a payment time of a payment application program, a payment credit limit of a user in a payment application program, a call-up sequence of payment application programs specified by the first entity, and a call-up sequence of the payment application programs specified by the third entity.
